(19) United States
(12) Patent Application Publication
(10) Pub. No.: US 2005/0053007 A1
(43) Pub. Date: Mar. 10, 2005

(54) Route selection in mobile ad-hoc networks based on traffic state information

(75) Inventors: Richard Charles Bernhardt, Melbourne, FL (US); Joseph Bibb Cain, Indialantic, FL (US); William Anthony Windham, Palm Bay, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation, Melboume, FL (US)

(21) Appl. No.: 10/657,960

(22) Filed: Sep. 9, 2003

(51) Int. Cl. H04L 12/26

(52) U.S. Cl. 370/238; 370/252; 370/328; 370/338

(57) ABSTRACT

Message data is routed from a source node to a destination node in a mobile ad hoc network (MANET) having a plurality of intermediate mobile nodes between a source node and a destination node, and a plurality of wireless communication links connecting the nodes together. Traffic state information is obtained about the intermediate nodes between the source node and the destination node. The traffic state information includes node resource utilization information, node residual capacity information, and node transit delay information. Candidate routes are discovered from the source node to the destination node, and one or more routes are selected from among the candidate routes to distribute message data to the destination node based upon the number of intermediate nodes and the traffic state information obtained for each of the intermediate nodes on the discovered route.

### FIELD OF THE INVENTION

The present invention relates to the field of communications networks, and, more particularly, to mobile ad hoc networks and related methods.

### BACKGROUND OF THE INVENTION

Wireless networks have experienced increased development in the past decade. One of the most rapidly developing areas is mobile ad-hoc networks (MANETs). Physically, a MANET includes a number of geographically-distributed, potentially mobile nodes sharing one or more common radio channels. Compared with other types of networks, such as cellular networks or satellite networks, the most distinctive feature of MANETS is the lack of any fixed infrastructure. The network is formed of mobile and stationary nodes, and is created on the fly as the nodes communicate with each other. The network does not depend on a particular node and dynamically adjusts as some nodes join or others leave the network.

In a hostile environment where a fixed communication infrastructure is unreliable or unavailable, such as in a battle field or in a natural disaster area struck by earthquake or hurricane, a MANET can be quickly deployed to provide much needed communications. While the military is still a major driving force behind the development of these networks, ad-hoc networks are quickly finding new applications in civilian or commercial areas. MANETs will allow people and applications to exchange data in the field or in a class room without using any network structure except that which they create by simply turning on their computers or PDAs.

As wireless communication increasingly permeates everyday life, new applications for MANETs will continue to emerge and become an important factor in wireless communications. Yet, MANETs pose serious challenges to designers. Due to the lack of a fixed infrastructure, nodes must self-organize and reconfigure as they move, join or leave the network. All nodes are essentially the same, and there is no natural hierarchy or central controller in the network. All functions have to be distributed among the nodes. Nodes are often powered by batteries and have limited communication and computation capabilities. Also, the bandwidth of the system is usually limited. The distance between two nodes often exceeds the radio transmission range, and a transmission may have to be relayed by other nodes before reaching its destination. Consequently, a MANET network typically has a multi-hop topology, and this topology changes as the nodes move around.

The MANET working group of the Internet Engineering Task Force (IETF) has been actively evaluating and standardizing routing protocols, including multicasting protocols. Because the network topology changes arbitrarily as the nodes move, information is subject to becoming obsolete, and different nodes often have different views of the network, both in time (information may be outdated at some nodes but current at others) and in space (a node may only know the network topology in its neighborhood and not far away from itself).

A routing protocol needs to adapt to frequent topology changes, possibly with less than accurate information. Because of these unique requirements, routing in these networks is very different than in others. Gathering fresh information about the entire network is often costly and impractical. Some routing protocols are reactive (i.e., on-demand) protocols. That is, they collect routing information only when necessary and only to destinations to which they need routes, and do not maintain unused routes. In this way the routing overhead may be reduced compared to pro-active protocols, which maintain optimal routes to all destinations at all time. Ad Hoc on Demand Distance Vector (AODV), Dynamic Source Routing (DSR) and Temporally Ordered Routing Algorithm (TORA) are representatives of reactive routing protocols presented at the MANET working group.

An example of a proactive routing protocol is Optimal Link State Routing (OLSR). Examples of other various routing protocols include Destination Sequenced Distance-Vector (DSDV) routing which is disclosed in U.S. Pat. No. 5,412,654 to Perkins, and the Zone Routing Protocol (ZRP) which is disclosed in U.S. Pat. No. 6,304,556 to Haas. ZRP is a hybrid protocol using both proactive and reactive approaches.

These conventional routing protocols use a best effort approach in selecting a route from the source node to the destination node. Typically, minimizing the number of hops is the main criteria in such approaches.

Quality-of-service (QoS) routing in MANETs is gaining interest. To provide quality-of-service, a protocol needs not only to find a route but also to identify and/or secure the resources along the route. Because of the potentially limited, shared bandwidth of the network, and the lack of a central controller which can account for and control these limited resources, nodes must negotiate with each other to manage the resources required for QoS routes. This is further complicated by frequent topology changes. Due to these constraints, QoS routing is more demanding than best-effort or minimum-hop routing.

Some examples of QoS routing approaches are set forth by Chenxi Zhu in the publication entitled “Medium Access Control and Quality-of-Service Routing for Mobile Ad Hoc Networks,” 2001, and by M. Mirhakkak et al. in the publication entitled “Dynamic Quality-of-Service for Mobile Ad Hoc Networks,” MITRE Corp., 2000. Zhu discusses establishing bandwidth guaranteed QoS routes in small networks whose topologies change at a low to medium rate. Mirhakkak et al. are concerned with resource reservation requests which specify a range of QoS values while the network makes a commitment to provide service within this range.

Since MANETs are still in the initial stages of development, most attempts to implement QoS functionality in MANETs thus far have focused primarily on using QoS parameters to establish routes, as is the case with some of the above-noted prior art approaches. Yet, as MANETs continue to increase in size and complexity, further QoS functionality may be needed along with ways to increase throughput and decrease delay.

### SUMMARY OF THE INVENTION

In view of the foregoing background, it is therefore an object of the present invention to provide a method, mobile node and mobile ad hoc network that increases throughput and decreases delay.

This and other objects, features, and advantages in accordance with the present invention are provided by a method for routing message data from a source node to a destination node in a mobile ad hoc network (MANET). The MANET has a plurality of intermediate mobile nodes between the source node and the destination node, and a plurality of wireless communication links connecting the nodes together. The method includes obtaining traffic state information about the intermediate nodes between the source node and the destination node. The traffic state information includes node resource utilization information, node residual capacity information, and node transit delay information. The method includes discovering candidate routes from the source node to the destination node, wherein a route is a series of intermediate nodes and wireless communication links from the source node to the destination node. Furthermore, one or more routes are selected from among the candidate routes to distribute message data to the destination node, based upon the number of intermediate nodes and the traffic state information obtained for each of the intermediate nodes on the discovered route.

The method may also include ranking the discovered candidate routes based upon the number of intermediate nodes and the traffic state information, and selecting the route is based upon the ranking. Also, ranking the discovered routes may include storing route entries in a route cache, each route entry corresponding to one of the discovered routes. Obtaining traffic state information may include periodic transmission of traffic state information between the nodes, requesting traffic state information from the nodes by the source node, and/or transmission of traffic state information between the nodes in response to a network event. Furthermore, node resource utilization information may include node traffic buffer utilization and/or node traffic queue utilization. Node residual capacity information may include available node capacity beyond that being used by unrelated traffic, while node transit delay information may include a time period from when a node receives message data to transmission of the message data.

Objects, features, and advantages in accordance with the present invention are also provided by a mobile node for use in a mobile ad hoc network defined by a plurality of mobile nodes and a plurality of wireless communication links connecting the plurality of mobile nodes together. The mobile node includes a communications device to wirelessly communicate with other nodes of the plurality of nodes via the wireless communication links, and a controller to route communications, e.g. message data, via the communications device. The controller includes a traffic state monitoring unit to obtain traffic state information about the plurality of nodes. The traffic state information includes resource utilization information, residual capacity information, and transit delay information. The controller further includes a route discovery unit to discover candidate routes to a destination node, a route ranking unit to rank candidate routes based upon the number of nodes and the traffic state information of the nodes on the candidate route, and a message data distribution unit to distribute the message data to the destination node along at least one candidate route based upon the rank.

The route ranking unit preferably stores route entries in a route cache, each route entry corresponding to one of the candidate routes. Also, the traffic state monitoring unit may periodically obtain traffic state information from the nodes, request traffic state information from the nodes, and/or obtain traffic state information from the nodes in response to a network event.

### BRIEF DESCRIPTION OF THE DRAWINGS

FIGS. 1 and 2 are schematic diagrams of a mobile ad hoc network in accordance with the present invention.

FIG. 3 is a flowchart illustrating the method steps for a mobile ad hoc network in accordance with the present invention.

FIG. 4 is a schematic diagram illustrating a router of a node in accordance with the network of the present invention.

FIG. 5 is a schematic diagram illustrating the details of the controller of the router in FIG. 4.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to flowchart illustrations of methods, systems, and computer program products according to an embodiment of the invention. It will be understood that blocks of the illustrations, and combinations of blocks in the illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions specified in the block or blocks.

These computer program instructions may also be stored in a computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer or other programmable apparatus implemented process such that the instructions which execute on the computer or other programmable apparatus provide steps for implementing the functions specified in the flowchart block or blocks.

As discussed above, most MANET routing protocols operate on the basis of providing a single route for the transmission of packets from the source to the destination, and often this is the route with the least number of hops. However, by providing multiple routes based upon traffic state information from intermediate nodes, it is possible for the source node to pick a route that minimizes, for example, delay, even though that route may not have the least number of hops. Multiple route choices can be selected on the basis of a particular aspect of traffic information, which is not necessarily the same information component for each intermediate node along the candidate path. This results in a more robust and reliable system, and provides advantages in the dynamic management of quality of service. The approach of the present invention uses a combination of information about the traffic state of the nodes leading to the destination, and the communication of such information to the source node, to aid in the discovery and selection of candidate routes.

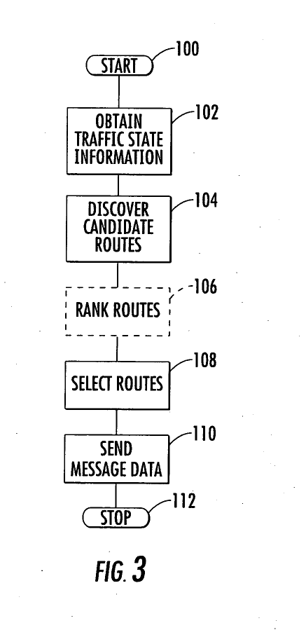

Referring initially to FIG. 1-4, a method for routing message data from a source node S to a destination node D in a mobile ad hoc network 20 will now be described. The network 20 includes a plurality of mobile nodes 30 including the source node S and the destination node D with intermediate nodes IN therebetween. The nodes 30, such as laptop computers, personal digital assistants (PDAs) or mobile phones, are connected by wireless communication links 32 as would be appreciated by the skilled artisan. The method begins (block 100) and includes obtaining traffic state information (block 102) about the intermediate nodes IN between the source node S and the destination node D. The traffic state information includes node resource utilization information, node residual capacity information, and node transit delay information. Node resource utilization information includes node traffic buffer utilization and/or node traffic queue utilization. Node residual capacity information includes available node capacity beyond that being used by unrelated traffic, while node transit delay information may include a time period from when a node receives message data to transmission of the message data.

At block 104, the method includes discovering candidate routes A, B from the source node S to the destination node D. A route is a series of intermediate nodes IN and wireless communication links 32 from the source node S to the destination node D. Furthermore, at block 106, the method may include ranking the discovered candidate routes A, B based upon the number of intermediate nodes IN and the traffic state information obtained for each of the intermediate nodes on the candidate route. One or more routes are selected (block 108) from among the candidate routes A, B to distribute message data (block 110) to the destination node D, based upon the ranking or the number of intermediate nodes IN and/or the traffic state information. As used herein, “message data” is intended to include any data that may be sent between nodes in the mobile ad-hoc network, including (but not limited to) video data, audio data, alphanumeric data, etc., as would be appreciated by the skilled artisan.

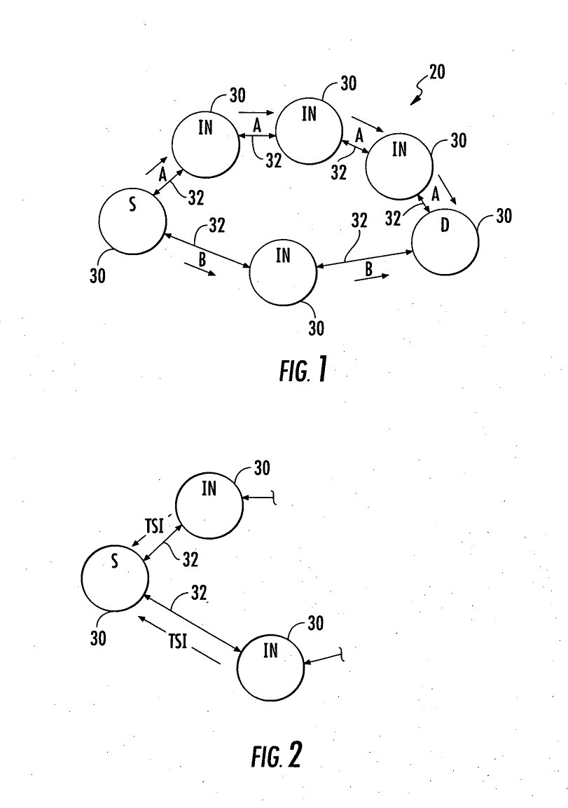

Ranking the discovered routes A, B may include storing route entries in a route cache with each route entry corresponding to one of the discovered routes. As illustrated in FIG. 2, obtaining traffic state information may include periodic transmission of traffic state information TSI between the nodes 30, requesting traffic state information from the nodes by the source node S, and/or transmission of traffic state information between the nodes in response to a network event.

The described method can be used in connection with any type of On-Demand or Reactive routing protocol, such as Dynamic Source Routing (DSR) or Ad-Hoc On-Demand Distance Vector (AODV) routing, or to any hybrid proactive/reactive protocol, such as Zone Routing Protocol (ZRP), as would be appreciated by the skilled artisan. The described procedures are easily applied to the DSR protocol. The conventional DSR message types RREQ, RREP, RRER are defined as optional packet types, and can be used as defined for the conventional operation of the protocol to support “best effort” traffic in a backwards compatibility mode. New optional packet types may be defined to support the measurement of traffic state metrics. Definition of the required header fields for these types is straightforward based on the functions defined above.

As discussed, the present invention provides the discovery and use of multiple routes. The routing cache/table is tailored to utilize up to n routes simultaneously per destination. Thus, as described, the present invention supports conventional ad hoc routing protocols such as DSR and AODV but can significantly improve performance. Multiple routes can be used for load balancing, and the use of multiple routes can provide more timely backup routes when path failures occur.

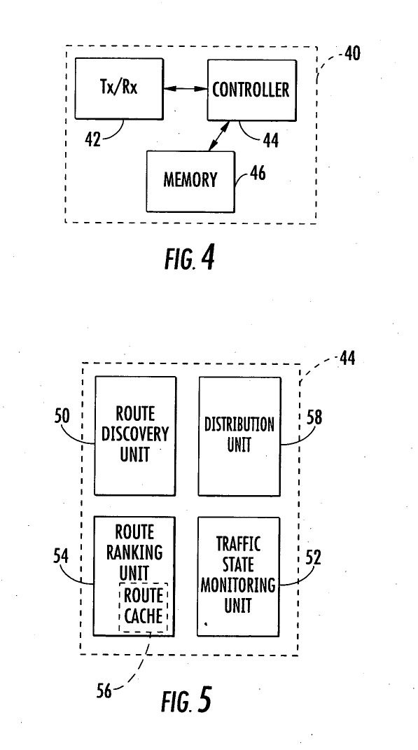

Referring now additionally to FIGS. 4 and 5, a system aspect of the invention will be described. A mobile ad hoc network 20 includes a plurality of mobile nodes 30, and a plurality of wireless communication links 32 connecting the plurality of mobile nodes together. Each mobile node includes a router 40 (FIG. 4) that has a communications device 42 to wirelessly and uni-directionally or bi-directionally communicate with other nodes via the wireless communication links 32, and a controller 44 to route communications via the communications device 42. Also, a memory 46 may be included as part of the controller 44 or in connection with the controller.

As shown in FIG. 5, the controller 44 includes a route discovery unit 50 to transmit route requests to other nodes to discover routing to a destination node. The controller 44 includes a traffic state monitoring unit 52 to obtain traffic state information about the plurality of nodes. Again, the traffic state information includes resource utilization information, residual capacity information, and transit delay information. The controller 44 further includes a route ranking unit 54 to rank candidate routes based upon the number of nodes and the traffic state information of the nodes on the candidate route, and a message data distribution unit 58 to distribute the message data to the destination node along at least one candidate route based upon the rank.

The route ranking unit 54 preferably stores route entries in a route cache 56, each route entry corresponding to one of the candidate routes. Also, the traffic state monitoring unit may periodically obtain traffic state information from the nodes, request traffic state information from the nodes, and/or obtain traffic state information from the nodes in response to a network event, as discussed above.

As discussed above, the approach of the present invention uses a combination of information about the traffic state of the nodes 30 leading to the destination D, and the communication of such information to the source node S, to aid in the discovery and selection of candidate routes. By providing multiple routes based upon traffic state information from intermediate nodes IN, it is possible for the source node S to pick a route that minimizes delay and increases throughput even though that route may not have the least number of hops. A more robust and reliable system is provided, and advantages in the dynamic management of quality of service are gained.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A method for routing message data from a source node to a destination node in a mobile ad hoc network comprising a plurality of intermediate mobile nodes between the source node and the destination node, and a plurality of wireless communication links connecting the nodes together, the method comprising:
obtaining traffic state information about the intermediate nodes between the source node and the destination node, the traffic state information including node resource utilization information, node residual capacity information, and node transit delay information;
discovering candidate routes from the source node to the destination node, a route comprising a series of intermediate nodes and wireless communication links from the source node to the destination node; and
selecting at least one route, from among the candidate routes to distribute message data to the destination node, based upon the number of intermediate nodes and the traffic state information obtained for each of the intermediate nodes on the discovered route.

2. A method according to claim 1 further comprising ranking the discovered candidate routes based upon the number of intermediate nodes and the traffic state information; wherein selecting the route is based upon the ranking.

3. A method according to claim 2 wherein ranking the discovered routes comprises storing route entries in a route cache, each route entry corresponding to one of the discovered routes.

4. A method according to claim 1 wherein obtaining traffic state information comprises periodic transmission of traffic state information between the nodes.

5. A method according to claim 1 wherein obtaining traffic state information comprises requesting traffic state information from the nodes by the source node.

6. A method according to claim 1 wherein obtaining traffic state information comprises transmission of traffic state information between the nodes in response to a network event.

7. A method according to claim 1 wherein node resource utilization information comprises node traffic buffer utilization.

8. A method according to claim 1 wherein node resource utilization information comprises node traffic queue utilization.

9. A method according to claim 1 wherein node residual capacity information comprises available node capacity beyond that being used by unrelated traffic.

10. A method according to claim 1 wherein node transit delay information comprises a time period from when a node receives message data to transmission of the message data.

11. A method for routing message data from a source node to a destination node in a mobile ad hoc network comprising a plurality of intermediate mobile nodes between the source node and the destination node, and a plurality of wireless communication links connecting the nodes together, the method comprising:
transmitting traffic state information among the nodes, the traffic state information including node resource utilization information, node residual capacity information, and node transit delay information;
discovering candidate routes from the source node to the destination node, a route comprising a series of intermediate nodes and wireless communication links from the source node to the destination node;
ranking the discovered candidate routes based upon the traffic state information; and
selecting at least one route, from among the candidate routes to distribute message data to the destination node, based upon the ranking.

12. A method according to claim 11 wherein ranking the discovered routes comprises storing route entries in a route cache, each route entry corresponding to one of the discovered routes.

13. A method according to claim 11 wherein transmitting traffic state information comprises periodic transmission of traffic state information between the nodes.

14. A method according to claim 11 wherein transmitting traffic state information comprises requesting traffic state information from the nodes by the source node.

15. A method according to claim 11 wherein transmitting traffic state information comprises transmission of traffic state information between the nodes in response to a network event.

16. A method according to claim 11 wherein node resource utilization information comprises node traffic buffer utilization.

17. A method according to claim 11 wherein node resource utilization information comprises node traffic queue utilization.

18. A method according to claim 11 wherein node residual capacity information comprises available node capacity beyond that being used by unrelated traffic.

19. A method according to claim 11 wherein node transit delay information comprises a time period from when a node receives message data to transmission of the message data.

20. A mobile node for use in a mobile ad hoc network defined by a plurality of mobile nodes and a plurality of wireless communication links connecting the plurality of mobile nodes together, the mobile node comprising:
a communications device to wirelessly communicate with other nodes of the plurality of nodes via the wireless communication links; and
a controller to route communications via the communications device, the communications comprising message data, the controller comprising
a traffic state monitoring unit to obtain traffic state information about the plurality of nodes, the traffic state information including resource utilization information, residual capacity information, and transit delay information;
a route discovery unit to discover candidate routes to a destination node,
a route ranking unit to rank candidate routes based upon the number of nodes and the traffic state information of the nodes on the candidate route, and
a message data distribution unit to distribute the message data to the destination node along at least one candidate route based upon the rank.

21. A mobile node according to claim 20 wherein the route ranking unit stores route entries in a route cache, each route entry corresponding to one of the candidate routes.

22. A mobile node according to claim 20 wherein the traffic state monitoring unit periodically obtains traffic state information from the nodes.

23. A mobile node according to claim 20 wherein the traffic state monitoring unit requests traffic state information from the nodes.

24. A mobile node according to claim 20 wherein the traffic state monitoring unit obtains traffic state information from the nodes in response to a network event.

25. A mobile node according to claim 20 wherein node resource utilization information comprises node traffic buffer utilization.

26. A mobile node according to claim 20 wherein node resource utilization information comprises node traffic queue utilization.

27. A mobile node according to claim 20 wherein node residual capacity information comprises available node capacity beyond that being used by unrelated traffic.

28. A mobile node according to claim 20 wherein node transit delay information comprises a time period from when a node receives message data to transmission of the message data.
